(19) United States
(12) Patent Application Publication
(10) Pub. No.: US 2021/0252428 A1
(43) Pub. Date: Aug. 19, 2021

(54) Defoamer Active, Manufacturing Method Thereof, and Defoaming Formulation

(71) Applicant: W.R. Grace & Co.-Conn., Columbia, MD (US)

(72) Inventor: Feng Gu, Columbia, MD (US)

(21) Appl. No.: 17/251,879

(22) PCT Filed: Jun. 13, 2019
(86) PCT No.: PCT/US2019/036944

§ 371 Date: Dec. 14, 2020

Related U.S. Application Data
(60) Provisional application No. 62/685,360, filed on Jun. 15, 2018.

(51) Int. Cl. B01D 19/04; C01B 33/26

(52) U.S. Cl. CPC B01D 19/0409; C01P 2006/12; C01P 2004/61; C01B 33/26

(57) ABSTRACT

This invention relates to a defoamer active. The defoamer active may include hydrophobized aluminum silicate particles. Aluminum silicate particles having a surface pH of at least about 9.6 and a BET surface area of less than about 150 m2/g are treated with a hydrophobilizing agent to provide the hydrophobized aluminum silicate particles. The defoamer actives are useful to prepare defoamer compositions which are useful for preventing or reducing foam in various aqueous systems.

### FIELD OF THE INVENTION

The present invention relates to a defoaming technology, and more particularly, to a defoamer active, a manufacturing method thereof, and a defoaming formulation.

### BACKGROUND

Hydrophobically treated inorganic particles have been used as defoamer actives in many areas including paper industry, paint, and coating formulations. Defoamer actives are used especially in waterborne systems to reduce and eliminate microbubbles or foams. Typically, silica particles are chemically bonded with silicone oil (polydimethylsiloxane or PDMS) to produce hydrophobically treated particles, which are then used as a defoamer active.

U.S. Pat. No. 3,573,222 discloses a composition useful for defoaming consisting essentially of from about 70 to about 95 parts by weight of a hydrocarbon fluid and from about 5 to about 30 parts by weight of a synthetic alkali metal or alkaline earth metal silico aluminate having an average particle size no greater than about 200 microns. The silico aluminate is made hydrophobic by reacting at a temperature of not exceeding about 75° C. with about 7% to about 30% of a halosilane based on a weight of the silico aluminate in the hydrocarbon or halocarbon fluid.

U.S. Pat. No. 4,008,173 discloses a composition containing finely divided synthetic, precipitated amorphous metal-silicates and an acid. The composition has a pH of 2 to 5 being suitable for use as a base for a defoamer for aqueous systems.

U.S. Pat. No. 5,575,950 discloses defoaming formulations for aqueous systems, which are produced by treating silicates such as sodium magnesium aluminosilicates with a source of aluminum to provide an aluminum content therein in a range of 0.1 to 2.5 wt. %, preferable 0.3 to 1.3 wt. %. Then, the aluminum treated silicate is hydrophobized with a silicone fluid, and then dispersed in oil and/or water to form the defoaming formulation.

Two conventional methods heretofore used to render hydrophilic silicates hydrophobic by surface treatment with a silicone fluid include “in-situ” and “dry roast” methods. Both methods are disclosed and described in U.S. Pat. No. 5,575,950, herein incorporated by reference. However, these methods may be disadvantageous due to process inefficiency and high associated costs.

For example, due to its very low surface tension or energy, when silicone oils are used as the hydrophobic agent, free, unreacted silicone oils can quickly spread to many surrounding surfaces. This phenomenon maybe detrimental to many aqueous systems. For example, in automobile paint systems, free silicone oil, especially the low molecular and very fluid silicone oils, has the tendency of overspreading all over the place and accordingly contaminating production halls from floor to ceiling. The free silicone oil can disrupt adhesion of paints and glues, cause foams to shrink, and generate paint defects sometimes referred as “fish eyes.” Therefore, in both aforementioned processes (i.e., in situ and dry roast), long reaction time is often required to ensure that the free, unreacted and physically adsorbed silicone oil levels are at minimal. Such long reaction times have shortcomings such as poor process efficiency with high cost.

Furthermore, the in situ and dry roast processes are typically batch processes and not continuous ones, thereby further limiting production cycles within a given time period.

Thus, there is a need to provide improved hydrophobized aluminum silicate particles and a process of preparing the same, which is quick, efficient and more cost effective.

### BRIEF SUMMARY

The present invention discloses that aluminum silicate particles such as sodium magnesium aluminum silicates having a high surface pH in combination with a low surface area unexpectedly provide enhanced reactivity to covalently bond silanol terminated PDMS, especially the silanol terminated PDMS having a high molecular weight or viscosity, to the surface thereof. This high reactivity has the unexpected advantage, for example, of significantly shortening the reaction time, thereby enabling the reaction to be carried out in a continuous mode as opposed to a batch process, which may require long reaction time. The obtained hydrophobized aluminum silicate particles have excellent hydrophobicity.

Accordingly, one embodiment of the present invention is a defoamer active. The defoamer active includes hydrophobized aluminum silicate particles. The hydrophobized aluminum silicate particles may be obtained by treating aluminum silicate particles having a BET surface area of less than 150 m²/g and a surface pH of at least 9.6 with a hydrophobilizing agent. The hydrophobilizing agent may be silanol terminated polydimethylsiloxane having an average molar molecular weight of at least 2000 Dalton (Da).

Another embodiment of the present invention is a method of forming a defoamer active. The method may include high energy milling and/or bonding aluminum silicate particles having a median particle size ranging from about 4 μm to about 50 μm with a hydrophobilizing agent in a high energy milling apparatus, which may include a spiral jet mill or fluid energy mill, to obtain hydrophobized aluminum silicate particles.

### BRIEF DESCRIPTION OF THE DRAWINGS

The subject matter which is regarded as the disclosure is particularly pointed out and distinctly claimed in the claims at the conclusion of the specification. The foregoing and other objects, features, and advantages of the disclosure are apparent from the following detailed description taken in conjunction with the accompanying drawings in which:

FIG. 1 shows results of a hydrophobicity test of hydrophobized particles according to one embodiment of the present invention;

FIG. 2 shows effect of different molecular weight/viscosity of silanol terminated PDMS on reaction kinetics according to one embodiment of the present invention; and

FIG. 3 shows effect of three TMS terminated PDMS with different molecular weights and one silanol terminated PDMS on reaction kinetics according to one embodiment of the present invention.

### DETAILED DESCRIPTION

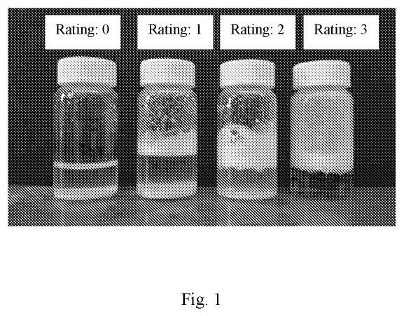

The present disclosure will be described in further detail with reference to the accompanying drawings and embodiments in order to provide a better understanding by those skilled in the art of the technical solutions of the present disclosure. Throughout the description of the present disclosure, reference is made to FIGS. 1-3.

The following terms, used in the present description and the appended claims, have the following definition.

A numerical range modified by “about” herein means that the upper and lower limits of the numerical range can vary by 10% thereof. A numerical value modified by “about” herein means that the numerical value can vary by 10% thereof.

The term “hydrophobized” is used herein to indicate aluminum silicate particles having a hydrophobicity rating of at least 2 on a scale range of 0 to 3.0, as measured according to a floatability method in a mixture solvent of methanol and water with a volume ratio of 60% to 40%.

One embodiment of the present invention is a defoamer active. The defoamer active may include hydrophobized aluminum silicate particles. The hydrophobized aluminum silicate particles may be obtained by treating aluminum silicate particles having a BET surface area of less than about 150 m²/g and a surface pH of at least about 9.6 with a hydrophobilizing agent. The hydrophobized aluminum silicate particles may have a median particle size ranging from about 2 μm to about 15 μm, preferably from about 4 μm to about 12 μm.

Aluminum silicates, also known as aluminosilicates, useful in the present invention, are chemical compounds that are derived from aluminum oxide, Al₂O₃, and silicon dioxide, SiO₂. In one embodiment, the starting aluminum silicate particles include an alkali metal/alkaline earth metal aluminum silicate. The alkali metal/alkaline earth metal aluminum silicate may contain at least an alkali metal selected from the group consisting of lithium, sodium, potassium, rubidium, cesium, and mixtures thereof. Furthermore, the alkali metal/alkaline earth metal aluminum silicate may contain at least an alkaline earth metal selected from the group consisting of beryllium, magnesium, calcium, strontium, barium, radium and mixtures thereof. In one embodiment, the alkali metal/alkaline earth metal aluminum silicate is sodium magnesium aluminum silicate.

In one embodiment, the BET surface area of the aluminum silicate particles is less than about 100 m²/g, preferably less than about 80 m²/g. The surface pH of the aluminum silicate particles is at least about 10. The surface pH of the aluminum silicate particles typically ranges from about 10 to about 12.

The aluminum silicate particles may have a median particle size in a range of about 4 μm to about 50 μm, preferably about 4.5 μm to about 30 μm, more preferably about 5.0 μm to about 15 μm.

The hydrophobilizing agent may be a silicone compound such as polydimethylsiloxane (PDMS or silicone oil), polymethylhydrogensiloxane, or polymethylphenylsiloxane. In an embodiment of the present invention, the silicone compound is polydimethylsiloxane. The polydimethylsiloxane may have an average molar mass of at least about 2,000 Dalton (Da), preferably ranging between about 3,000 Da to about 50,000 Da, more preferably ranging between about 5,000 Da to about 30,000 Da. The polydimethylsiloxane may be a silanol terminated polydimethylsiloxane. The silanol terminated polydimethylsiloxane may have a content of hydroxyl groups of at least about 0.001% by weight, preferably ranging from about 0.01% by weight to about 2.0% by weight, more preferably ranging from about 0.1% by weight to about 1.8% by weight. In one embodiment, the silanol terminated polydimethylsiloxane has a viscosity of at least about 50 centipoises, preferably ranging from about 100 centipoises to about 5000 centipoises, more preferably ranging from about 200 centipoises to 4000 centipoises.

Typically, the total amount of the hydrophobilizing agent covalently bonded or physically adsorbed in the hydrophobized aluminum silicate particles is an amount of no greater than about 12% by weight, preferably no greater than about 10% by weight, based on the total weight of the hydrophobized aluminum silicate particles. In one embodiment, the amount of the hydrophobilizing agent present on the hydrophobized particles ranges from about 8 to about 10 wt %, preferably about 8.5 to about 9.5 wt %, based on the total weight of the hydrophobized aluminum silicate particles.

The carbon content of the hydrophobized aluminum silicate particles is not more than about 3.50%, preferably not more than about 3.0%, more preferably from about 2.5% to about 3.0%.

The hydrophobized aluminum silicates may have hydrophobicity rating of at least 2 on a scale range of 0 to 3.0, as measured according to a floatability method in a mixture solvent of methanol and water with a volume ratio of 60% to 40%. Preferably, the hydrophobicity rating ranges from about 2 to about 3.

The hydrophobized aluminum silicate particles may be prepared using a conventional batch method or a continuous process. In either a batch or continuous process, it is preferable to conduct the process in a manner such that at least about 90% by weight, preferably at least about 95% by weight, of the total hydrophobilizing agent used in the process is covalently bonded to the final hydrophobized aluminum silicate particles. This ensures that any free unreacted silicone oil levels are kept at a minimal.

In one embodiment, the process is conducted in a manner such that a very low percentage or close to zero amount of the total amount of the hydrophobilizing agent is present on the silicate particles is present as a non-bonded, physically adsorbed component. Preferably, the amount of non-bonded, physically adsorbed hydrophobilizing agent is not more than about 10% by weight, preferably not more than about 6% by weight, based on a total weight of the hydrophobilizing agent used in the process. In a preferred embodiment, the amount of non-bonded, physically adsorbed hydrophobilizing agent present on the hydrophobized particles ranges from about 0% to about 5% based on a total weight of the hydrophobilizing agent used in the process

In one embodiment, the hydrophobized particles may be prepared by an in-situ method. During the in-situ method, aluminum silicate particles are reacted with hydroxy terminated silicone oil in mineral oil. The condensation reaction between the aluminum silicate particles and the silicone oil takes place at a fairly low temperature (limited to the flash point of the diluent such as 100-120° C.). The hydrophobized particles may also be prepared using a dry roast method. During the dry roast method, the aluminum silicate particles are reacted with the silicone oil (PDMS) (e.g. 100 cps) in a fluidized bed reactor to promote good contact between the aluminum silicate particles and the silicone oil. The condensation reaction between the aluminum silicate particles and the silicone oil takes place at about 260° C. Water is released during the condensation reaction as by-product. Once the hydrophilic aluminum silicate particles become hydrophobic, silicone dioxide is suspended in the diluent such as mineral or silicone oil. Surfactants and wetting agents are then further added.

In a preferred embodiment, the hydrophobized aluminum silicate particles are prepared by a continuous process using a high energy mill, e,g. a spiral jet mill or a fluid energy mill. A spiral jet mill is mainly used for grinding particles to a specific particle size distribution. During the process, a fluid, typically compressed air, is injected into a grinding chamber of the spiral jet mill through nozzles that are tangentially aligned to create a vortex slightly smaller than the grinding ring itself. The air flowing through the nozzles reaches sonic velocities and causes comminution between particles in the grinding chamber. A natural classification process occurs from the fluid vortex, causing larger particles to be retained in the mill and smaller particles to exit. The high airflow to solid ratio and the turbulent conditions make the spiral jet mill a desirable processing equipment to complete surface reaction of particles by coating/mixing the reactants and heating them to quickly drive the reaction to completion.

In one embodiment, particles are added to the spiral jet mill while silanol terminated polydimethylsiloxane, PDMS, is being injected into a turbulent zone of the spiral jet mill simultaneously. The particles are uniformly coated with the PDMS which reacts with the hydroxyl groups on the surface of the particles to form hydrophobized particles. This process is desirable for producing hydrophobized particles since it can be run continuously and also combines the grinding and surface reaction into one processing step.

Another example of the present invention is a defoaming formulation comprising a deformer active according to one embodiment of the present disclosure. The defoaming formulation may also contain other known components such as secondary defoaming agents, carriers, emulsifiers, coupling or stabilizing agents, or the like. The secondary defoaming agents may include fatty alcohols, fatty esters, silicones, and certain oil insoluble polymers. The carriers may include hydrocarbon oils or water. Examples of emulsifiers may include esters, ethoxylated products, sorbitan esters, silicones, and alcohol sulfates. Example of coupling agents may include red oil (oleic acid), hexylene glycol, fatty alcohols, naphthalene sulfonate, butyl alcohol, and formaldehyde.

While not intending to be limiting, and depending on the intended use of the deforming formulations, the defoaming formulation may include about 70 to 97% by weight of mineral oil, optionally, about 0.5 to about 3% by weight of surfactants, and about 3% to about 30%, preferably about 5 to about 20% by weight of hydrophobic defoamer actives.

Defoaming formulations comprising the deformer actives of the invention may be utilized in many types of manufacturing processes to break macro- and micro-bubbles and defoam aqueous systems. Major industries in which the formulations may be used include, but are not limited to, the manufacture of paper, the manufacture of paints and coatings, water treatment facilities, the manufacture of textiles, and in oil fields. As will be understood by one skilled in the arts, the defoaming formulations of the invention may be used in such aqueous systems in conventional amounts depending on the intended use.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Hereinafter, the present invention will be described in more detail with reference to Examples. However, the scope of the present invention is not limited to the following Examples.

### EXAMPLES

### Materials

In the following examples, silicone oil and polydimethylsiloxane or PDMS are used interchangeably. Table 1 lists properties of the particles used such as median particle size (PS) D50, BET surface area (BET), and particle pore volume (PV).

TABLE 1

| | | PS | | |
|---|---|---|---|---|
| Particle | | D50 | BET | PV |
| Identification | Material | (μm) | (m²/g) | (cc/g) |
| P-1 | Precipitated | 5.5 | 52 | 0.27 |
| | aluminosilicate | | | |
| P-2 | Precipitated | 9.0 | 52 | 0.27 |
| | aluminosilicate | | | |

In the Table, P-1 and P-2 are precipitated magnesium aluminosilicate particles (the two differ only in particle sizes) are prepared from the reaction of sodium silica and aluminum sulfate, in the present of magnesium chloride. The process was similar to that as described in EP0701534. Some products are commercially available, and can be purchased from companies like W. R. Grace & Co.

Table 2 lists properties of the PDMS used in the following examples. PDMS-1 to PDMS-3 are silanol terminated, and PDMS-4 to PDMS-6 are trimethyl silyl (TMS) terminated. PDMS-1 is available from Dow Corning (Midland, Mich.), PDMS-2 and PDMS-3 are available from Momentive Performance Materials (Waterford, N.Y.), PDMS-4, PDMS-5, and PDMS-6 are available from Wacker Chemie AG (Munich, Germany).

TABLE 2

| | | (OH) | Molar | |
|---|---|---|---|---|
| | Silanol/TMS | content | MW | Viscosity |
| Identification | Termini | (Wt %) | (Da) | (cPs) |
| PDMS-1 | Silanol | 2.5 | 1400 | 92 |
| PDMS-2 | Silanol | 0.23 | 15000 | 635 |
| PDMS-3 | Silanol | 0.14 | 35000 | 4012 |
| PDMS-4 | TMS | None | 3780 | 51 |
| PDMS-5 | TMS | None | 6000 | 98 |
| PDMS-6 | TMS | None | 13600 | 376 |

Here below are structures of the two types of PDMS:

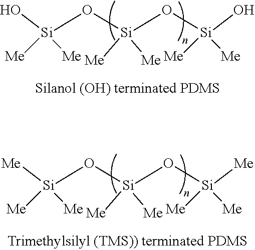

In Table 2, for both the silanol terminated PDMSs and the TMS terminated PDMSs, the average molar molecular weights are provided by chemical suppliers. The average molar molecular weight can be measured by a gel permeation chromatography (GPC) technique.

In Table 2, the viscosities of the silanol terminated PDMSs and the TMS terminated PDMSs are also provided by chemical suppliers. The viscosities of PDMS can be measured using a Brookfield DV-II+Pro viscometer (available from Brookfield Engineering Laboratories, Inc., Middleboro, Mass.), with stands and associated spindle sets. The measurements are carried out at room temperature and the procedure (Single Point Viscosity method) is provided by Brookfield in its manual. The recommended procedure is similar to what is described in ASTM D2983.

Also, in Table 2, the (OH) contents of the silanol terminated PDMSs are provided by chemical suppliers. For the silanol terminated PDMS, the OH contents can also be calculated based on the following principle:

Each linker PDMS consists of two OH groups, and therefore the weight percent of OH groups on each chain is:

OH content %=2×17/MW of the polymer×100%

For example, for a polymer chain of molar molecular weight of 15,000 Dalton's, OH content %=2×17/15000=0.226%.

### General Bonding Procedures

### Bonding Procedure 1:

Both a 2 L round bottom flask and the starting particles were oven dried, for example, at 120° C. for about 12 hours. In 2 L round bottom flask was charged with the oven-dried starting particles. Then, a certain amount of PDMS was added into the flask using a pipette dropwise while the flask was frequently shaken so that the starting particles and the PDMS were mixed as homogeneously as possible. For a high molecular weight silicone oil with a high viscosity, a small amount of toluene was used to dissolve the PDMS, and then the dissolved PDMS is added. The mixture of the PDMS and the particles was allowed to roll on a rotavap at room temperature for at least about 5 hours to about 12 hours. Then, the mixture of the PDMS and the particles was transferred into a crystalline dish, which was then placed in a fume hood for a few hours to allow toluene, if used, to evaporate. Finally, the crystalline dish containing the mixture of the PDMS and the particles was placed in an oven and baked at 120° C. for about 12 hours.

### Bonding Procedure 2:

Milling/grinding method: a certain amount of particles and a certain amount of PDMS were placed in a mortar pestle, and the mixture was grinded manually for 30 minutes to 1 hour. This process could be replaced with milling, for example, in a clean ball mill. Then, the mixture was transferred into a crystalline dish, which was then placed in an oven and baked at 120° C. for about 12 hours.

### Bonding Procedure 3:

A 10″ spiral jet mill with eight 0.011″ grind holes was used. The grinding chamber of the spiral jet mill was modified so that a 0.8 mm nozzle could be inserted from outside to inside of the grinding ring wall. This nozzle was connected to a metering pump which was used to meter in the PDMS.

Specifically, the bonding procedure includes the following steps. First, the mill superheater was brought up to a temperature, for example, in a range from 300 F to 340 F. An Acrison Loss-in-weight feeder was filled with the particles to be milled. The feeder was set to a constant rate of 40 lb/hr of particles. During the bonding, the temperature of the mill superheater was constantly being adjusted by a control system to keep the mill outlet temperature between 300-340 F, and the mill grinding pressure and injection pressure were controlled at 18 and 80 psig, respectively. Then, a pre-calibrated metering pump was turned on to inject PDMS through the nozzle into the milling chamber. As such, the particles and PDMS were being added to the mill at the same time. This process continues until a desired amount of milled-hydrophobic product was produced.

### Testing Methods

The particle sizes were determined by a light scattering method using a Malvern Mastersizer 2000 or 3000 available from Malvern Instruments Ltd. per ASTM B822-10.

The “BET surface area” of the particles was measured by the Brunauer Emmet Teller nitrogen adsorption method (Brunauer et al, J. Am. Chem. Soc., 1938, 60(2), 309-319).

The carbon content of the particles was measured using a LECO Carbon Analyzer SC-632 available from LECO Corp.

### Hydrophobicity Test

The hydrophobicity of the hydrophobized particles was measured by a floatability method. The hydrophobicity test was performed by placing dried hydrophobic particles into a mixture solvent of methanol and water with a volume ratio of 60%/40%. Specifically, about 0.25 g of hydrophobized particles were placed in a small, 20 ml vial containing about 6 ml of the mixture solvent. After some vigorous shaking (˜20 times), the hydrophobized particles were fully mixed with the mixture solvent. After 30 minutes, the floating properties of the hydrophobized particles were visually examined with a rating of 0 (nothing floating, all settled at the bottom of the vial), 1 (about 50% floating), 2 (about 75% floating), and 3 (all particles floating, and nothing settled at the bottom of the vial), as shown in FIG. 1.

A rating of 3 or close to 3 with certain approximation (e.g., greater than 95% of the particles floating) indicated that the hydrophobized particles had the highest hydrophobicity and are not wettable in the mixture solvent. This was the highest possible rating and is preferred for the performance of the hydrophobized particles.

### Free Silicone Evaluation:

A percentage of chemically bonded PDMS vs. physically adsorbed PDMS was evaluated using a free silicone evaluation method. Adsorbed PMDS could be desorbed and become free, and these were detrimental to the system and environment as described in the embodiments. The method of evaluating an amount of free PDMS included the following steps:

1). During a washing step, the hydrophobized particles were extensively washed with toluene. After 4 times of washing, the hydrophobized particles were dried at 110° C. for 4 hours.

2). Elemental carbon analysis was carried out on the hydrophobized particles before and after the washing step by a combustion method with a LECO instrument. The results of the elemental carbon analysis on hydrophobized particles after the washing step were compared against those of the hydrophobized particles before the washing step, that is, the unwashed, hydrophobized particles.

3). A difference between the carbon values on the hydrophobized particles before and after the washing step was calculated. This difference was an indication of the amount of physically adsorbed PDMS. A value of zero or close to zero suggests 100% or close to 100% of the PMDS were chemically bonded.

### Reaction Kinetics Study:

The reaction at a certain temperature was monitored against time such as minutes to hours. Aliquots were taken at certain times, and samples were washed with toluene as described in the free silicone evaluation. Then, the samples were evaluated regarding C % and percentage of reaction completion by dividing the measured C % with the C % of the unwashed samples.

### Acidic Treatment of Particles

To study influence of surface pH of starting particles, for the starting particles having a high surface pH (e.g., SM405 or P-1/P-2, with a pH of around 10.7), a dilute sulfuric acid was used to lower the surface pH, and the particles were filtered and dried for bonding study.

### Example 1

### Hydrophobicity of Hydrophobized Particles

Precipitated aluminosilicate P-1 was treated with PDMS-1 using bonding procedure 1. 10% by weight of PDMS based on a total weight of the precipitated aluminosilicate P-1 and the PDMS-1 was used. Hydrophobicity of the hydrophobized aluminosilicate P-1 was measured as 3, as shown in Table 3 below.

TABLE 3

| | | | | Amount | |
|---|---|---|---|---|---|
| | | | | of PDMS | Hydro- |
| Example | Choice of | Choice of | Bonding | used | phobicity |
| Number | Particles | PDMS | Method | (w/w) | rating |
| 1 | P-1 | PDMS-1 | Bonding | 10% | 3 |
| | | | procedure 1 | | |

As shown in Table 3, the precipitated aluminosilicate P-1 treated with PDMS-1 achieved excellent hydrophobicity results.

### Examples 2-4

### Influence of Surface pH of Particles on Reaction Kinetics

Aluminosilicate particles P-1 were hydrophobized with PDMS-2. Since the natural pH of aluminosilicate particles P-1 is around 10.7 (Example 2), two lower pH samples, Examples 3 and 4, were obtained by acidic treatment as discussed in the section of acidic treatment of particles. Bonding procedure 1 was used for the bonding. The heat treatment at 85° C. was performed for the time study.

TABLE 4

| | Reaction Completion | | |
|---|---|---|---|
| Heat Treatment | Example 4 | Example 3 | Example 2 |
| Time (hr) | pH 8.95 | pH 9.86 | pH 10.64 |
| 0 (after mixing | 18% | 24% | 40% |
| at room | | | |
| temperature) | | | |
| 0.5 | 19% | 27% | 48% |
| 1 | 63% | 74% | 91% |

As shown in Table 4, Examples 2-4 show importance of particle surface pH on the reaction completion. A higher surface pH is preferred for the reaction to complete in a shorter time.

### Examples 5-7

### Influence of Molecular Weight/Viscosity of PDMS on Reaction Kinetics

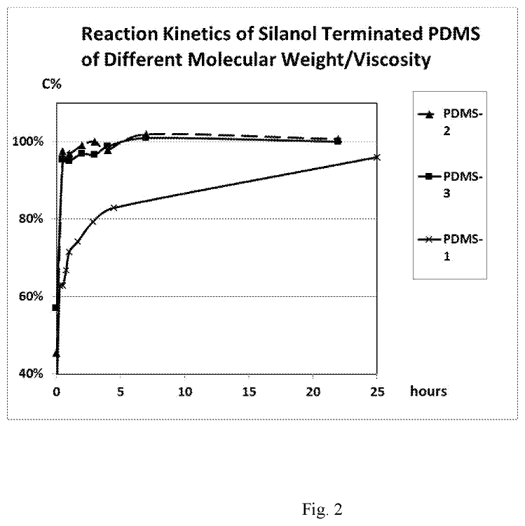

In these examples, silanol terminated PDMS with different molecular weight/viscosity were compared using P-1 particles for the study at 85° C. heat treatment temperature. Specifically, Examples 5-7 were hydrophobized with PDMS-1, PDMS-2, and PDMS-3 respectively. Results of reaction kinetics of OH terminated PDMS with different molecular weight/viscosity are shown in FIG. 2. As shown in FIG. 2, Examples 5-7 show that a PDMS having a higher molecular weight/viscosity has much faster reaction kinetics.

### Examples 8-11

### Comparison of Silanol Terminated and TMS Terminated PDMS on Reaction Kinetics

Three TMS terminated PDMS with different molecular weights (Example 8: PDMS-4; Example 9: PDMS-5; Example 10: PDMS-6) and viscosities were compared against silanol terminated PDMS: PDMS-2 (Example 11). Aluminosilicate particles P-1 with a high surface pH were used in these examples. 10% of PDMS based on a total weight of the aluminosilicate particles and the PDMS were mixed with the dried aluminosilicate particles at room temperature, and bonding procedure 2 was performed for 60 minutes. Then, the samples were heated at 85° C. for 10 mins and 60 mins, and evaluated for bonding completion.

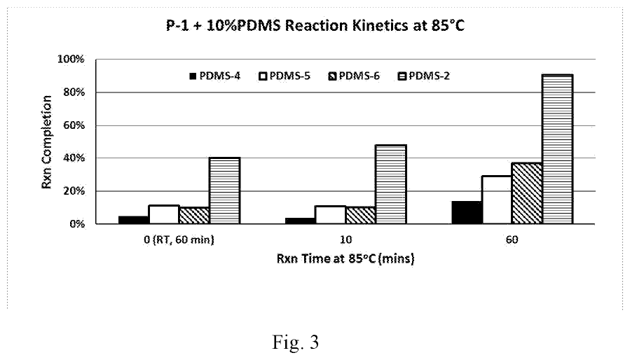

As can be seen in FIG. 3, after 60 minutes at 85° C., the reaction involving silanol terminated PDMS, PDMS-2, was almost complete while the other three TMS terminated PDMSs were at most less than 40% completion. The order of the completion ratio for the three PDMSs were PDMS-6>PDMS-5>PDMS-4, following similar trend as shown in Examples 5-7.

The same samples were further heated at 120° C. for about 12 hours. Results of completion ratios and hydrophobicity ratings are shown in the following table 5:

TABLE 5

| Sample, | | | | Hydro- | |
|---|---|---|---|---|---|
| (120° C., about | Description | | | phobicity | Rxn |
| 12 hours) | Particle | Silicone | % used | rating | Completion |
| Example 8 | P-1 | PDMS-4 | 10 | 0 | 42% |
| Example 9 | P-1 | PDMS-5 | 10 | 0 | 58% |
| Example 10 | P-1 | PDMS-6 | 10 | 0.5 | 83% |
| Example 11 | P-1 | PDMS-2 | 10 | 3 | 97% |

As shown in Table 5, even at 120° C. for about 12 hours, the reactions for the three TMS terminated PDMS were not close to completion.

Finally, the same samples were further heated at 260° C. for 5 hours (Table 6). In these cases, all of the reactions were at completion. However, there were still significant differences in hydrophobicity testing rating in that a high molecular weight/viscosity sample (Example 10) gives much better performance than the other smaller molecular weight samples (Examples 8 and 9).

TABLE 6

| | | | | Hydro- | |
|---|---|---|---|---|---|
| Sample, | Description | | | phobicity | Rxn |
| (260° C., 5 hrs) | Particle | Silicone | % | Rating | Completion |
| Example 8 | P-1 | PDMS-4 | 10 | 1 | 94% |
| Example 9 | P-1 | PDMS-5 | 10 | 2 | 101% |
| Example 10 | P-1 | PDMS-6 | 10 | 3 | 99% |

### Example 12

### Spiral Jet Mill Production of Hydrophobized Particles

The use of a 10 inch spiral jet mill or fluid energy mill as described in bonding procedure 3 is demonstrated in Example 12. The following paragraph lists the running conditions, and Table 7 shows results of the bonding completion and hydrophobic performance rating.

The running conditions are as follows: particle feed rate was about 40 lb/hr; additive feed rate was about 45 g/min; superheater temperature was about 1000 F; injection temperature was about 350 F; injection pressure was about 80 psi; grind temperature was about 612 F; grind pressure was about 18 psi; outlet temperature mill was about 320 F; and baghouse temperature was about 300 F. The following table 7 shows results of bonding completion and hydrophobic performance rating.

TABLE 7

| | | | | Incoming | Product | | |
|---|---|---|---|---|---|---|---|
| Example | | | PDMS | APS | APS | Conversion | Hydrophobicity |
| # | Particles | PDMS | ratio | (μm) | (μm) | % | Rating |
| 12 | P-2 | PDMS-2 | 10% | 9.0 | 4.4 | 95% | 3 |

As shown in Table 7, the use of spiral jet mill or fluid energy mill is feasible for the production of hydrophobic particles. The reaction can be accomplished with some reduction of average particle size (APS), which can be adjusted with different milling conditions to satisfy the particle size needs. Most importantly, this is a continuous process with the potential of large scale commercial production.

1. A defoamer active, comprising:
hydrophobized aluminum silicate particles comprising aluminum silicate particles having a surface pH of at least about 9.6 and a BET surface area of less than about 150 m²/g which have been treated with a hydrophobilizing agent to provide the hydrophobilizing agent on the aluminum silicate particles.

2. The defoamer active according to claim 1, wherein the aluminum silicate particles have a median particle size ranging from about 5 μm to about 50 μm.

3. The defoamer active according to claim 1, wherein the hydrophobized aluminum silicate particles have a median particle size ranging from about 2 μm to about 15 μm.

4. The defoamer active formed according to claim 1, wherein the BET surface area of the aluminum silicate particles is less than about 100 m²/g.

5. (canceled)

6. The defoamer active according to claim 1, wherein the surface pH of the aluminum silicate particles is at least about 10.

7. The defoamer active of claim 1, wherein the aluminum silicate particles comprise an alkali metal/alkaline earth metal aluminum silicate.

8. The defoamer active of claim 7, wherein the alkali metal/alkaline earth metal aluminum silicate contains at least an alkali metal selected from the group consisting of lithium, sodium, potassium, rubidium, cesium, and mixtures thereof.

9. The defoamer active of claim 7, wherein the alkali metal/alkaline earth metal aluminum silicate contains at least an alkaline earth metal selected from the group consisting of beryllium, magnesium, calcium, strontium, barium, radium and mixtures thereof.

10. The defoamer active of claim 7, wherein the alkali metal/alkaline earth metal aluminum silicate is sodium magnesium aluminum silicate.

11. The defoamer active according to claim 1, wherein the hydrophobilizing agent is a silicone compound.

12. The defoamer active according to claim 11, wherein the silicone compound is polydimethylsiloxane, wherein the polydimethylsiloxane has an average molar mass of at least about 3,000 Da.

13. The defoamer active according to claim 12, wherein the polydimethylsiloxane has an average molar mass of at least about 10,000 Da.

14. The defoamer active according to claim 12, wherein the polydimethylsiloxane is a silanol terminated polydimethylsiloxane.

15. The defoamer active according to claim 14, wherein the silanol terminated polydimethylsiloxane has a content of hydroxyl group of at least 0.10% by weight.

16. (canceled)

17. The defoamer active according to claim 1, wherein the hydrophobilizing agent is in an amount of not more than 10% by weight based on a total weight of the aluminum silicate particles and the hydrophobilizing agent.

18. The defoamer active according to claim 1, wherein a carbon content of the hydrophobized aluminum silicate particles is not more than 3.0%.

19. The defoamer active according to claim 1, wherein at least 90% by weight of the hydrophobilizing agent is covalently bonded to the aluminum silicate particles.

20. (canceled)

21. The defoamer active according to claim 1, wherein the hydrophobized aluminum silicate particles have hydrophobicity rating of at least 2, as measured according to a floatability method in a mixture solvent of methanol and water with a volume ratio of 60% to 40%.

22. (canceled)

23. A defoaming formulation, comprising the deformer active according to claim 1.

24. A coating formulation, comprising the defoaming formulation according to claim 23.

25. A method of forming a defoamer active, comprising:
milling and bonding aluminum silicate particles with a hydrophobilizing agent using a spiral jet mill or fluid energy mill to obtain hydrophobized aluminum silicate particles,
wherein a surface pH of the aluminum silicate particles is at least 9.6, a BET surface of the aluminum silicate particles is less than 100 m²/g and a median particle size of the aluminum silicate particles ranges from about 2 μm to about 50 μm.

26. The method of forming a defoamer active according to claim 25, wherein milling and bonding the aluminum silicate particles with the hydrophobilizing agent using the spiral jet mill or fluid energy mill to obtain the hydrophobized aluminum silicate particles comprises:
adding the aluminum silicate particles and the hydrophobilizing agent into the spiral jet mill; and
milling and heating the aluminum silicate particles and the hydrophobilizing agent in the spiral jet mill to form the hydrophobized aluminum silicate particles.

27. (canceled)

28. The method of forming a defoamer active according to claim 26, wherein the total amount of hydrophobilizing agent is present in the hydrophobized aluminum silicate particles in an amount no greater than 10 wt %, based on the total weight of the hydrophobized aluminum silicate particles.

29. The method of forming a defoamer active according to claim 26, wherein the aluminum silicate particles comprise a sodium magnesium aluminum silicate.

30. (canceled)

31. The method of forming a defoamer active according to claim 26, wherein the hydrophobilizing agent is polydimethylsiloxane, wherein the polydimethylsiloxane has an average molar mass of at least 3000 Da.

32. The method of forming a defoamer active according to claim 31, wherein the polydimethylsiloxane is a silanol terminated polydimethylsiloxane.

33-36. (canceled)
